(19) United States
(12) Patent Application Publication
(10) Pub. No.: US 2024/0349351 A1
(43) Pub. Date: Oct. 17, 2024

(54) METHOD FOR RANDOM ACCESS IN WIRELESS COMMUNICATION SYSTEM AND APPARATUS FOR THE SAME

(71) Applicant: ELECTRONICS AND TELECOMMUNICATIONS RESEARCH INSTITUTE, Daejeon (KR)

(72) Inventors: Seok SEO, Daejeon (KR); Hyung Jin KIM, Daejeon (KR); Ki Soon SUNG, Daejeon (KR); Sung Min OH, Daejeon (KR); Seong Chul CHO, Daejeon (KR); You Sun HWANG, Daejeon (KR)

(21) Appl. No.: 18/595,103

(22) Filed: Mar. 4, 2024

(30) Foreign Application Priority Data
Apr. 14, 2023 (KR) 10-2023-0049213

(51) Int. Cl. H04W 74/0833; H04W 56/00; H04W 74/08

(52) U.S. Cl. CPC H04W 74/0833; H04W 56/0045; H04W 74/0866

(57) ABSTRACT

A random access method performed by a communication node may comprise: receiving RACH configuration information; measuring a distance between a base station and a terminal or a signal characteristic value corresponding to the distance between the base station and the terminal; determining a timing offset value to be applied to random access preamble transmission using the signal characteristic value, preset threshold value, and preset timing offset value; and transmitting a random access preamble generated on the basis of the RACH configuration information to the base station, wherein the threshold value and the timing offset value are included in the RACH configuration information.

### CROSS-REFERENCE TO RELATED APPLICATION

This application claims priority to Korean Patent Application No. 10-2023-0049213, filed on Apr. 14, 2023, with the Korean Intellectual Property Office (KIPO), the entire contents of which are hereby incorporated by reference.

### BACKGROUND

### 1. Technical Field

The present disclosure relates to a random access technique in a wireless communication system, and more specifically, to a random access method and apparatus in a wireless communication system using a relatively shorter cyclic prefix of a random access preamble.

### 2. Related Art

Random access is a procedure for a terminal to generate a connection to a network. This is one common procedure in wireless communication systems including Global System for Mobile Communications (GSM), Universal Mobile Telecommunication System (UMTS), Long-Term Evolution (LTE), narrowband-Internet of things (NB-IoT), and Fifth Generation (5G) New Radio (NR).

The terminal attempting voice and/or data communication in a mobile communication system using limited radio resources may request a base station to establish a connection through a process called the random access. The random access may be generally used for the following purposes. First, it may be used to form a radio link as an initial access. Second, it may be used to re-form a radio link after a radio link failure (RLF). Third, it may be used to re-establish a radio link after the RLF. Fourth, it may be used for uplink synchronization with a new cell in a handover procedure. Fifth, when a terminal is in an RRC_CONNECTED state but its uplink is not synchronized, it may be used to acquire an uplink synchronization with a base station due to arrival of uplink or downlink data. Sixth, it may be used for making a scheduling request (SR) when there is no scheduling request resource designated on a physical uplink control channel (PUCCH).

The random access procedure usually starts with a terminal transmitting a random access preamble to an uplink through a random access channel (RACH). The random access preamble transmission is to synchronize the uplink between the terminal and a base station and to request resources for transmitting a message such as a radio resource control (RRC) connection request Msg3.

FIG. 1 shows a random access procedure between a terminal and a base station. As shown in FIG. 1, a terminal 10 acquires RACH configuration information for random access preamble transmission by receiving system information, for example, a system information block 2 (SIB2) message, from a base station 30. The terminal 10 generates a random access preamble Msg1 by selecting a random access preamble from a set of predefined preambles based on the acquired RACH configuration information and transmits the generated Msg1 to the base station 30 in the uplink through a RACH.

The base station 30 continuously monitors whether the preamble signal is received in a section where RACH transmission is possible, detects the random access preamble, and estimates a round trip delay (RTD) value for uplink synchronization. In addition, the base station 30 transmits a random access response (RAR) message Msg2 including the detected preamble information, timing advance (TA) information, and uplink grant (UL grant) information to the terminal 10 in a downlink. Here, a TA value corresponds to an RTD value and may be given in units of 16×Ts (e.g., seconds). Here, Ts may be a sampling period and may be determined according to a system bandwidth.

The terminal 10 performs uplink synchronization using the TA information acquired through the RAR message Msg2 and transmits the connection request message Msg3, such as the RRC connection request message and a scheduled transmission message, for uplink data transmission using resource allocation information included in the UL grant information through a data channel. In addition, the base station 30 transmits a message Msg4, which transfers contention resolution information in order to avoid an overlap for use of the same random access resource, to the terminal 10.

In general, as shown in FIG. 2, a random access preamble 50 transmitted from the terminal 10 to the base station 30 is formed of a cyclic prefix CP with a T_{CP} length and a sequence with a T_{SEQ} length and may be formed of repeated sequence portions in order to overcome a poor channel environment.

A cell radius of the base station to allow the terminal is determined by a CP length, that is, T_{CP}, and the CP length should increase in proportion to an allowable cell radius. However, as the CP length becomes longer, energy used for CP transmission of the terminal increases and energy available for preamble sequence transmission decreases, and thus the reception signal-to-noise power ratio (SNR) performance of a random access preamble sequence signal can be degraded.

Also, from a system resource perspective, as the CP length becomes longer, efficiency of resource use decreases.

### SUMMARY

Accordingly, the present disclosure provides a method for random access in a wireless communication system that allows a cell radius to be wider than that of a prior method despite using a CP length that is shorter than that of the prior method.

The present disclosure further provides an apparatus for random access in a wireless communication system that allows a cell radius to be wider than that of a prior apparatus despite using a CP length that is shorter than that of the prior apparatus.

According to an embodiment of the present disclosure, a method for random access in a wireless communication system, method, performed by a communication node, may comprise: receiving random access channel (RACH) configuration information from a base station; measuring a distance between the base station and a terminal which is corresponded to the communication node or a signal characteristic value corresponding to the distance between the base station and the terminal; determining a timing offset value to be applied to random access preamble transmission using the signal characteristic value, preset threshold value information, and preset timing offset value information; and transmitting a random access preamble generated on the basis of the RACH configuration information to the base station, wherein the threshold value information and the timing offset value information are included in the RACH configuration information.

In the determining of the timing offset value, when a downlink sub-frame is received with a delay time corresponding to 0.5 times a round trip delay (RTD) from a transmission start point of the downlink sub-frame of the base station, the timing offset value may be determined to be a value that is smaller than the RTD.

In the transmitting of the random access preamble, the random access preamble may be transmitted through a RACH of an uplink at an earlier time point by a time corresponding to the timing offset value than a reception time point of the downlink sub-frame.

The signal threshold value information and the timing offset value information may be set to correspond to an allowable cell radius, an acceptable measurement error, and a frequency band used in the wireless communication system.

The timing offset value may be determined to correspond to the distance between the base station and the terminal or correspond to the signal characteristic value corresponding to the distance.

The signal characteristic value may include a path loss value; and the path loss value may be measured using reference signal transmission power and reference signal reception power, and information on the reference signal transmission power may be provided from the base station or through a network.

The random access method may further comprise estimating a distance to the base station using a measured value of a time of arrival (ToA) of a signal, wherein the measured value of the ToA is included in the signal characteristic value.

The signal characteristic value may include a quality index of reference signal received power (RSRP), a received signal strength indicator (RSSI), reference signal received quality (RSRQ), a signal-to-interference noise ratio (SINR), or a combination thereof.

When the signal characteristic value is less than the preset threshold value, a first preset timing offset value may be selected, and when the signal characteristic value is greater than or equal to the preset threshold value, a second preset timing offset value may be selected.

The second timing offset value may be greater than or equal to the first timing offset value. The first timing offset value and the second timing offset value may be zero or more and smaller than a cyclic prefix (CP) length of the random access preamble.

When the signal characteristic value is not set, the timing offset value may be zero.

When the first timing offset value and the second timing offset value are set to be the same, the timing offset value to be applied to the random access preamble transmission may be zero.

The random access method may further comprise receiving a random access response (RAR) message corresponding to the random access preamble from the base station in a downlink.

The RAR message may include preamble information, timing advance (TA) information, and uplink (UL) information, which are detected by the base station.

The determining of the timing offset value may include calculating a final TA value to be applied to the uplink transmission using the selected timing offset value and a TA value acquired through the RAR message.

The random access method may further comprise synchronizing an uplink using the final TA value.

The random access method may further comprise transmitting a scheduled transmission message or a radio resource control (RRC) connection request message through a data channel using resource allocation information included in UL grant information from the base station.

According to another embodiment of the present disclosure, an apparatus for random access in a wireless communication system may comprise: a radio frequency front end configured to receive a signal from an antenna and convert the received signal into digital data; and a processor configured to process the digital data provided from the radio frequency front end, wherein the processor is configured to: receive random access channel (RACH) configuration information from a base station; measure a distance between the base station and a terminal which is corresponded to the apparatus or a signal characteristic value corresponding to the distance between the base station and the terminal; determine a timing offset value to be applied to random access preamble transmission using the signal characteristic value, preset threshold value information, and preset timing offset value information; and transmit a random access preamble generated on the basis of the RACH configuration information to the base station, and the threshold value information and the timing offset value information may be included in the RACH configuration information.

When a downlink sub-frame is received with a delay time corresponding to 0.5 times a round trip delay (RTD) from a transmission start point of the downlink sub-frame of the base station, the processor may determine the timing offset value to be a value that is smaller than the RTD.

The processor may transmit the random access preamble through a RACH of an uplink at an earlier time point by a time corresponding to the timing offset value than a reception time point of the downlink sub-frame.

According to the present disclosure, a random access method that can accommodate a wider cell radius than the existing method is provided, despite using a cyclic prefix (CP) with a shorter length than that of the existing method in a random access preamble signal.

Furthermore, according to the present disclosure, the energy consumed for CP transmission can be further reduced relative to the existing method due to the use of the shorter CP length, and the energy available for transmitting a random access preamble sequence can be relatively increased, so that a reception signal-to-noise power ratio (SNR) performance for the random access preamble can be remarkably improved.

Furthermore, according to the present disclosure, the same cell radius as the existing method can be accommodated with the shorter CP length compared to the existing method, thereby improving the efficiency of resource use compared to the existing method.

### BRIEF DESCRIPTION OF DRAWINGS

FIG. 1 is a diagram illustrating a random access procedure when a terminal is initially connected to a network.

FIG. 2 is a diagram illustrating a general random access preamble configuration.

FIG. 3 is an exemplary diagram illustrating an arrangement of terminals with different timing advances (TAs) according to one embodiment of the present disclosure.

FIG. 4 is a diagram illustrating a general downlink timing relationship between the terminals and the base station of FIG. 3.

FIG. 5 is an exemplary diagram for describing a random access method according to one embodiment of the present disclosure through a timing relationship between the terminals and the base station of FIG. 3.

FIG. 6 is a flowchart illustrating a random access method according to one embodiment of the present disclosure.

FIG. 7 is a flowchart illustrating a process of determining the timing offset value applied to the random access method of FIG. 6.

FIG. 8 is a schematic block diagram illustrating a random access apparatus according to another embodiment of the present disclosure.

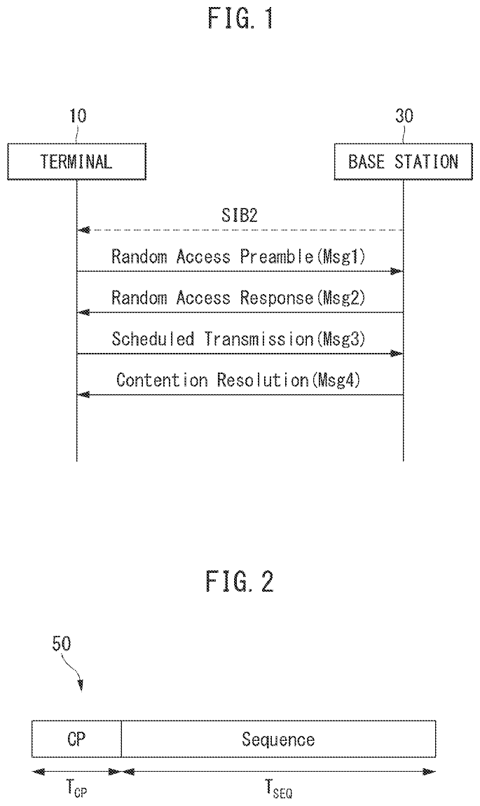

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system or a memory system to which exemplary embodiments according to the present disclosure are applied will be described. The communication system or memory system to which exemplary embodiments according to the present disclosure are applied is not limited to the content described below, and the exemplary embodiments according to the present disclosure are applicable to various communication systems. Here, the communication system may be used in the same sense as a communication network.

Additionally, a wireless communication network to which exemplary embodiments according to the present disclosure are applied will be described. The wireless communication networks to which exemplary embodiments according to the present disclosure are applied are not limited to those described below, and the exemplary embodiments according to the present disclosure are applicable to various wireless communication networks.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

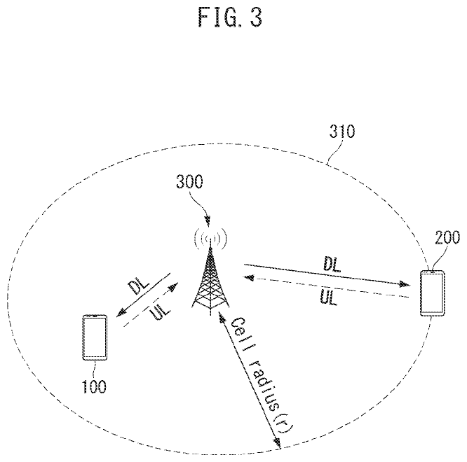

FIG. 3 is an exemplary diagram illustrating an arrangement of terminals with different timing advances (TAs) according to one embodiment of the present disclosure.

As shown in FIG. 3, the arrangement of a first terminal 100 and a second terminal 200, which are located at different distances from a base station 300 and have different TA values, is illustrated. The first terminal 100 is located at a relatively closer distance from the base station 300 than the second terminal 200, and the second terminal 200 is located at a cell boundary 310. The cell boundary 310 has a predetermined cell radius (r) from the base station 300.

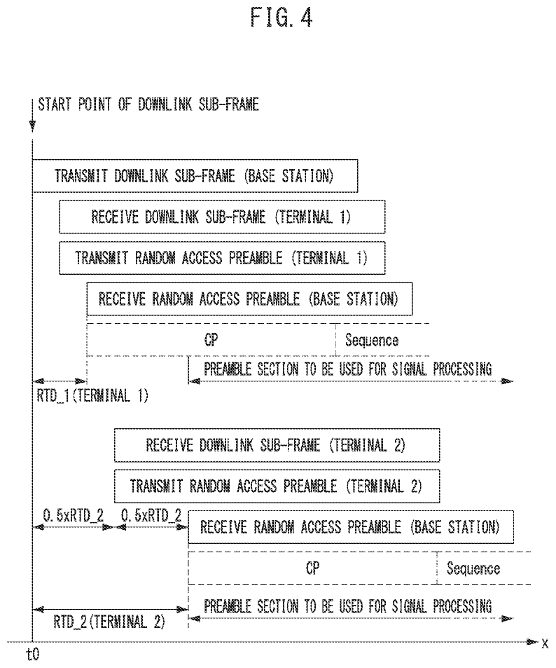

FIG. 4 is a diagram illustrating a general downlink timing relationship between the terminals and the base station of FIG. 3.

Referring to FIG. 4, each of the terminals 100 and 200 (see FIG. 3) receives a downlink sub-frame with a delay time corresponding to 0.5×Round Trip Delay (RTD) from a start point of the downlink sub-frame with a specific time point t0 and transmits a random access preamble in an uplink through a random access channel (RACH) based on a reception point of the downlink sub-frame. The delay time is displayed as 0.5×RTD_1 for the terminal 1 and as 0.5×RTD_2 for the terminal 2.

The base station 300 (see FIG. 3) receives a random access preamble signal after a delay time corresponding to 0.5×RTD from a transmission time point of the random access preamble. Therefore, the base station receives the random access preamble signal after the time delay corresponding to the RTD from the start point of the downlink sub-frame. The time delay corresponding to the RTD is displayed as RTD_1 for the terminal 1 and as RTD_2 for the terminal 2.

The base station measures an RTD using the received random access preamble signal and determines a TA value on the basis of the measured RTD. The corresponding TA value is used to determine a preamble section to be used in signal processing and is provided to the terminal through a random access response (RAR) message. The terminal completes uplink synchronization by applying the TA value acquired through the RAR message to an uplink transmission timing.

The RTD is determined by a distance between the base station and the terminal, and when expressed in an equation, the RTD given as RTD=2d/c. Here, d (meters) denotes the distance between the base station and the terminal, c (meters/sec) is a speed of radio waves given as 3×10⁸ m/s, and the RTD (meters) indicates the round trip delay.

In the case of terminal 2 located at the cell boundary, a distance between the terminal 2 and the base station may be considered to have the same value as the cell radius r. Consequently, the CP length allowing a cell radius corresponding to r should have at least the same value as the RTD. When a cell radius r allowable through a given CP length T_{CP} is expressed as an equation, it is given as r (meter)={T_{CP} (sec)×c (meter/sec)}/2. Therefore, the allowable cell radius and the CP length T_{CP} have a mutual proportional relationship.

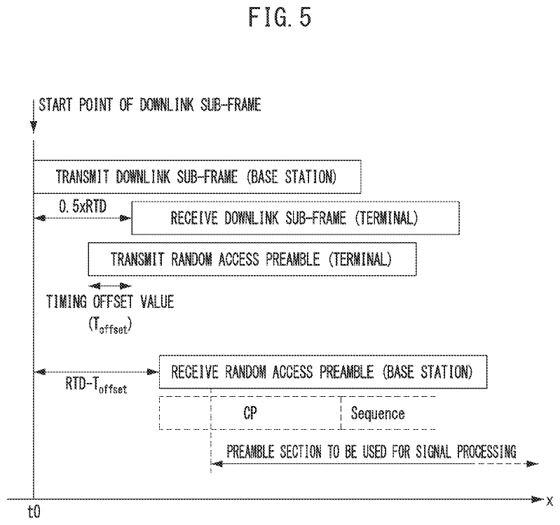

FIG. 5 is an exemplary diagram for describing a random access method according to one embodiment of the present disclosure through a timing relationship between the terminals and the base station of FIG. 3.

Referring to FIG. 5, the terminal 100 or 200 (see FIG. 3) receives a downlink sub-frame with a delay time (hereinafter referred to as a “first delay time”) corresponding to 0.5×RTD from a start point of a downlink sub-frame with a specific time point to from the base station 300 (see FIG. 3) and transmits a random access preamble in an uplink through the RACH at a time point prior to the reception time point of the downlink sub-frame by a time corresponding to a timing offset value T_{offset}. In this case, the base station receives a random access preamble signal after a delay time (hereinafter referred to as a “second delay time”) corresponding to a time obtained by subtracting the timing offset value T_{offset} from the first delay time 0.5×RTD from the transmission time point of the random access preamble. Consequently, the base station receives the random access preamble signal after a time delay (hereinafter referred to as a “third delay time”) corresponding to RTD-T_{offset} from the start point of the downlink sub-frame.

According to the present embodiment, when compared to the existing method of receiving the random access preamble signal after the time delay corresponding to the RTD from the start point of the downlink sub-frame, the random access preamble signal may be received at an earlier time point by the time corresponding to the timing offset value T_{offset}.

In this way, in the random access method according to the present embodiment, when the terminal measures and acquires the distance between the base station and the terminal or a signal characteristic value corresponding to the distance, determines the timing offset value T_{offset} corresponding to the acquired distance between the base station and the terminal or the signal characteristic value, and transmits the random access preamble signal to the base station at the earlier time point by the time corresponding to the timing offset value T_{offset}, the terminal may allow a larger cell radius compared to the existing method while using a shorter CP length.

As one example, path loss may be used as a representative signal characteristic value that can correspond to the distance between the terminal and the base station. The terminal may measure a path loss value using reference signal transmission power and reference signal reception power measured at the terminal. Here, the reference signal transmission power may be information provided to the terminal from the network. In addition, the terminal may estimate the distance between the base station and the terminal on the basis of a measured value for a timing of arrival (ToA) of radio waves. In the following description, signal characteristics such as the distance between the base station and the terminal and the path loss may be collectively referred to as characteristic values.

In determination of a timing offset value corresponding to the characteristic value, the terminal may use preset signal threshold value information and preset timing offset value information. Here, the preset signal threshold value information and the timing offset value information may be set to correspond to an allowable cell radius, an acceptable measurement error, and a frequency bandwidth used in the system and may be included in RACH configuration information and provided to the terminal.

In the present specification, in order to distinguish a preset timing offset value from a timing offset value corresponding to the characteristic value, the preset timing offset value is referred to as the existing timing offset value, a timing offset value before change, or a timing offset value #0, and the timing offset value corresponding to the characteristic value may be referred to as the timing offset value of the present embodiment, a timing offset value after change, or a timing offset value #1.

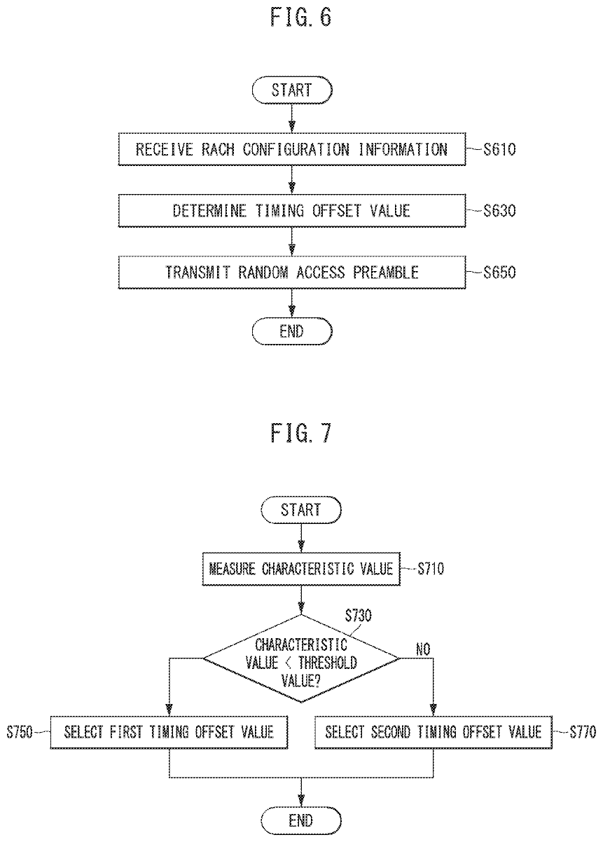

FIG. 6 is a flowchart illustrating a random access method according to one embodiment of the present disclosure.

Referring to FIG. 6, the random access method may include receiving, by the terminal, RACH configuration information from the base station for random access (S610), measuring a distance between the base station and the terminal or a signal characteristic value corresponding to the distance between the base station and the terminal, determining a timing offset value to be applied to random access preamble transmission using the signal characteristic value, preset signal threshold value information, and preset timing offset value information (S630), and transmitting a random access preamble generated on the basis of the RACH configuration information to the base station (S650). The RACH configuration information may include characteristic threshold value information and timing offset value information.

In this way, in the random access method, the terminal transmits the random access preamble to the base station at an earlier time point by a time corresponding to a timing offset value determined according to the method of the present embodiment from a time point of receiving a downlink sub-frame in the transmitting of the random access preamble.

FIG. 7 is a flowchart illustrating a process of determining the timing offset value applied to the random access method of FIG. 6.

Referring to FIG. 7, the determining of the timing offset value (S630) (see FIG. 6) of the random access method may include measuring, by the terminal, a characteristic value (S710). In this case, when the measured characteristic value is less than a preset threshold value (YES of S730), the terminal may select a first preset timing offset value (S750), and when the measured characteristic value is greater than or equal to the preset threshold value (NO of S750), the terminal may select a second preset timing offset value (S770).

Meanwhile, in the random access method according to the present embodiment, various operations of determining a timing offset value may be applied selectively or in combination. As one example, the random access method may include measuring, by the terminal, path loss. In this case, when a measured path loss value is less than a preset path loss threshold value, the terminal may select the first preset timing offset value, and when the measured path loss value is greater than or equal to the preset path loss threshold value, the terminal may select the second preset timing offset value.

As another example, the determining of the timing offset value may include measuring, by the terminal, a distance between the base station and the terminal. In this case, when the measured distance between the base station and the terminal is less than a preset distance threshold value, the terminal may select the first preset timing offset value, and when the measured distance between the base station and the terminal is greater than or equal to the preset distance threshold value, the terminal may select the second preset timing offset value.

In the determining of the timing offset value, quality indexes that the terminal may utilize as characteristic values, including reference signal received power (RSRP), a received signal strength indicator (RSSI), reference signal received quality (RSRQ), and a signal-to-interference noise ratio (SINR), may be used. For example, when measured RSRP (RSRQ, RSSI, or SINR) is greater than a preset threshold value, the terminal selects the first preset timing offset value, and when the measured RSRP (RSRQ, RSSI, or SINR) is less than or equal to the preset threshold value, the terminal selects the second preset timing offset value.

Alternatively, in the determining of the timing offset value, the second timing offset value may be set to a value that is greater than the first timing offset value. The first timing offset value may be given as zero, and the second timing offset value may be given as a value selected from or set in the range of zero to the CP length.

Alternatively, in the determining of the timing offset value, when the first timing offset value and the second timing offset value are set to be the same, the terminal may select zero as a timing offset value corresponding to the characteristic value.

Alternatively, in the determining of the timing offset value corresponding to the characteristic value, when a characteristic threshold value is not set, the terminal may select zero as the timing offset value.

In the random access method according to the present embodiment, the embodiments consisting of the first threshold value, the first timing offset, and the second timing offset have been described, but the random access method according to the present disclosure may expand to use N characteristic threshold values and N+1 timing offset values. Here, an N^{th} threshold value may be given as a value that is greater than an (N−1)^{th} threshold value, and an (N+1)^{th} timing offset value may be given as a value that is greater than an N^{th} timing offset value.

In addition, in the uplink synchronization method according to the present embodiment, a final TA value TAₜₒₜ to be applied to the uplink transmission may be obtained by the following equation 1 using a timing offset value T_{offset} selected in the determining of the timing offset value and a TA value obtained through a corresponding RAR message.

$${TA}_{tot} = {T}_{offset} + TA \qquad [ Equation 1 ]$$

In this way, the terminal may complete the uplink synchronization by adjusting an uplink transmission timing to an earlier time point by a time corresponding to the TAₜₒₜ value from the reception time point of the downlink sub-frame.

In a communication system including communication nodes such as a terminal and a base station, the random access apparatus for performing the random access method according to the above-described embodiment may support 4G communication (e.g., Long-Term Evolution (LTE) and LTE-advanced (A)) and 5G communication (e.g., New Radio (NR)), which are specified in the 3^{rd} Generation Partnership Project (3GPP) standard. The 4G communication may be performed in a frequency band of 6 GHz or below, and the 5G communication may be performed in a frequency band of 6 GHz or above as well as 6 GHz or below.

For example, for the 4G communication and 5G communication, a plurality of communication nodes may support a code division multiple access (CDMA)-based communication protocol, a wideband CDMA (WCDMA)-based communication protocol, a time division multiple access (TDMA)-based communication protocol, a frequency division multiple access (FDMA)-based communication protocol, an orthogonal frequency division multiplexing (OFDM)-based communication protocol, a filtered OFDM-based communication protocol, a cyclic prefix (CP)-OFDM-based communication protocol, a discrete Fourier transform-spread-OFDM (DFT-s-OFDM)-based communication protocol, an orthogonal frequency division multiple access (OFDMA)-based communication protocol, a single carrier (SC)-FDMA-based communication protocol, a non-orthogonal multiple access (NOMA)-based communication protocol, a generalized frequency division multiplexing (GFDM)-based communication protocol, a filter bank multi-carrier (FBMC)-based communication protocol, a universal filtered multi-carrier (UFMC)-based communication protocol, and a space division multiple access (SDMA)-based communication protocol.

In addition, the communication system may further include a core network. When the communication system supports the 4G communication, the core network may include a serving-gateway (S-GW), a packet data network (PDN)-gateway (P-GW), and a mobility management entity (MME). When the communication system supports the 5G communication, the core network may include a user plane function (UPF), a session management function (SMF), and an access and mobility management function (AMF).

In addition, a communication system including a plurality of base stations and a plurality of terminals may be an “access network.” Some base stations among the plurality of base stations may each form a macro cell, and other base stations thereamong may each form a small cell.

Here, each of the plurality of base stations may be a NodeB, an evolved NodeB, a base transceiver station (BTS), a radio base station, a radio transceiver, an access point, an access node, a road side unit (RSU), a radio remote head (RRH), a transmission point (TP), a transmission and reception point (TRP), eNB, or a next generation NodeB (gNB).

Each of the plurality of terminals may be a user equipment (UE), a terminal, an access terminal, a mobile terminal, a station, a subscriber station, a mobile station, a portable subscriber station, a node, a device, an Internet of things (IoT) device, or a mounted device (mounted module/device/terminal or on-board device/terminal.

Meanwhile, the plurality of base stations may operate in different frequency bands or may operate in the same frequency band. The plurality of base stations may be connected to each other through an ideal backhaul link or a non-ideal backhaul link and may exchange information with each other through the ideal backhaul link or the non-ideal backhaul link. Each of the plurality of base stations may be connected to the core network through the ideal backhaul link or the non-ideal backhaul link. Each of the plurality of base stations may transmit a signal received from the core network to a corresponding terminal and transmit a signal received from the corresponding terminal to the core network.

Each of the plurality of base stations may be a NodeB, an evolved NodeB, a BTS, a radio base station, a radio transceiver, an access point, an access node, an RSU, an RRH, a TP, a TRP, or a gNB. In addition, at least some of the base stations may be central unit (CU) nodes or distributed unit (DU) nodes, to which function separation is applied and may be referred to as cells.

Each of the plurality of terminals may be a UE, a terminal, an access terminal, a mobile terminal, a station, a subscriber station, a mobile station, a portable subscriber station, a node, a device, an IoT device, or a mounted device (mounted module/device/terminal or on-board device/terminal.

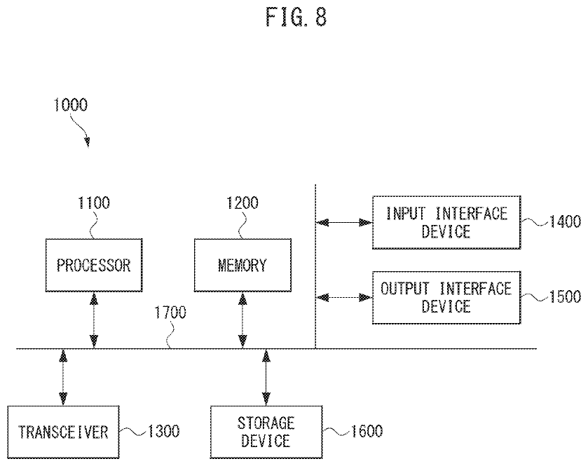

Meanwhile, in the above-described communication system, the base station and the terminal performing the random access procedure may each have structure of the apparatus which will described below with reference to FIG. 8.

FIG. 8 is a schematic block diagram illustrating a random access apparatus according to another embodiment of the present disclosure.

Referring to FIG. 8, a random access apparatus 1000 may include at least one processor 1100, a memory 1200, and a transceiver 1300 connected to a network and configured to perform communication. Further, the random access apparatus 1000 may further include an input interface device 1400, an output interface device 1500, and a storage device 1600. The components included in the random access apparatus 1000 may be connected by a bus 1700 to communicate with each other.

Instead of the common bus 1700, the components included in the random access apparatus 1000 may be connected through an individual interface or an individual bus based on the processor 1100. For example, the processor 1100 may be connected to at least one among the memory 1200, the transceiver 1300, the input interface device 1400, the output interface device 1500, and the storage device 1600 through a dedicated interface.

The processor 1100 may execute a program command stored in at least one of the memory 1200 and the storage device 1600. The processor 1100 may be a central processing unit (CPU), a graphics processing unit (GPU), or a dedicated processor in which methods according to embodiments of the present disclosure are performed. Each of the memory 1200 and the storage device 1600 may be formed of at least one of a volatile storage medium and a nonvolatile storage medium. For example, the memory 1200 may be formed as at least one of a read only memory (ROM) and a random access memory (RAM).

The transceiver 1300 may be provided with an antenna and a radio frequency (RF) front end configured to receive a signal from the antenna and convert the received signal into digital data. The processor 1100 may process the digital data provided from the RF front end and perform a series of operations of the random access method.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method for random access in a wireless communication system, performed by a communication node, the method comprising:
receiving random access channel (RACH) configuration information from a base station;
measuring a signal characteristic value corresponding to a distance between the base station and a terminal which is the communication node;
determining a timing offset value to be applied to random access preamble transmission using the signal characteristic value, preset threshold value information, and preset timing offset value information; and
transmitting a random access preamble generated on the basis of the RACH configuration information to the base station,
wherein the threshold value information and the timing offset value information are included in the RACH configuration information.

2. The method of claim 1, wherein, in the determining of the timing offset value, when a downlink sub-frame is received with a delay time corresponding to 0.5 times a round trip delay (RTD) from a transmission start point of the downlink sub-frame of the base station, the timing offset value is determined to be a value that is smaller than the RTD.

3. The method of claim 1, wherein, in the transmitting of the random access preamble, the random access preamble is transmitted through a RACH of an uplink at an earlier time point by a time corresponding to the timing offset value than a reception time point of the downlink sub-frame.

4. The method of claim 1, wherein the threshold value information and the timing offset value information are set to correspond to an allowable cell radius, an acceptable measurement error, and a frequency band used in the wireless communication system.

5. The method of claim 1, wherein the timing offset value information is determined to correspond to the distance between the base station and the terminal or correspond to the signal characteristic value corresponding to the distance.

6. The method of claim 5, wherein:
the signal characteristic value includes a path loss value; and
the path loss value is measured using reference signal transmission power and reference signal reception power, and information on the reference signal transmission power is provided from the base station or through a network.

7. The method of claim 5, further comprising estimating a distance to the base station using a measured value of a time of arrival (ToA) of a signal, wherein the measured value of the ToA is included in the signal characteristic value.

8. The method of claim 5, wherein the signal characteristic value includes a quality index of reference signal received power (RSRP), a received signal strength indicator (RSSI), reference signal received quality (RSRQ), a signal-to-interference noise ratio (SINR), or a combination thereof.

9. The method of claim 5, wherein, when the signal characteristic value is less than a preset threshold value, a first preset timing offset value is selected, and when the signal characteristic value is greater than or equal to the preset threshold value, a second preset timing offset value is selected.

10. The method of claim 9, wherein:
the second timing offset value is greater than or equal to the first timing offset value; and
the first timing offset value and the second timing offset value are zero or more and smaller than a cyclic prefix (CP) length of the random access preamble.

11. The method of claim 5, wherein, when the signal characteristic value is not set, the timing offset value is zero.

12. The method of claim 2, wherein, when the first timing offset value and the second timing offset value are set to be the same, the timing offset value to be applied to the random access preamble transmission is zero.

13. The method of claim 1, further comprising receiving a random access response (RAR) message corresponding to the random access preamble from the base station in a downlink.

14. The method of claim 13, wherein the RAR message includes preamble information, timing advance (TA) information, and uplink (UL) information, which are detected by the base station.

15. The method of claim 14, wherein the determining of the timing offset value includes calculating a final TA value to be applied to the uplink transmission using the selected timing offset value and a TA value acquired through the RAR message.

16. The method of claim 15, further comprising synchronizing an uplink using the final TA value.

17. The random access method of claim 8, further comprising transmitting a scheduled transmission message or a radio resource control (RRC) connection request message through a data channel using resource allocation information included in UL grant information from the base station.

18. An apparatus for random access in a wireless communication system, the apparatus comprising:
a radio frequency front end configured to receive a signal from an antenna and convert the received signal into digital data; and
a processor configured to process the digital data provided from the radio frequency front end,
wherein the processor is configured to:
receive random access channel (RACH) configuration information from a base station;
measure a signal characteristic value corresponding to a distance between the base station and a terminal which is corresponded to the apparatus for random access;
determine a timing offset value to be applied to random access preamble transmission using the signal characteristic value, preset threshold value information, and preset timing offset value information; and
transmit a random access preamble generated on the basis of the RACH configuration information to the base station,
wherein the threshold value information and the timing offset value information are included in the RACH configuration information.

19. The apparatus of claim 18, wherein, when a downlink sub-frame is received with a delay time corresponding to 0.5 times a round trip delay (RTD) from a transmission start point of the downlink sub-frame of the base station, the processor determines the timing offset value to be a value that is smaller than the RTD.

20. The apparatus of claim 19, wherein the processor transmits the random access preamble through a RACH of an uplink at an earlier time point by a time corresponding to the timing offset value than a reception time point of the downlink sub-frame.
